(19) United States
(12) Patent Application Publication
(10) Pub. No.: US 2025/0370719 A1
(43) Pub. Date: Dec. 4, 2025

(54) ELECTRONIC CONTROL DEVICE AND METHOD FOR GENERATING RANDOM NUMBERS

(71) Applicant: DENSO CORPORATION, Kariya-city (JP)

(72) Inventors: Hiroshi SAKAMOTO, Kariya-city (JP); Masaya TAKI, Kariya-city (JP)

(21) Appl. No.: 19/214,298

(22) Filed: May 21, 2025

(30) Foreign Application Priority Data
May 28, 2024 (JP) 2024-086540

(51) Int. Cl. G06F 7/58

(52) U.S. Cl. CPC G06F 7/588

(57) ABSTRACT

A plurality of random numbers is generated in an electronic control device having a function of generating the plurality of random numbers. A unique value that is different each time one of the random numbers is generated is acquired. An inherent value that is inherent to the electronic control device is acquired. One of the random numbers is generated using the unique value and the inherent value.

### CROSS REFERENCE TO RELATED APPLICATION

The present application claims the benefit of priority from Japanese Patent Application No. 2024-086540 filed on May 28, 2024. The entire disclosure of the above application is incorporated herein by reference.

### TECHNICAL FIELD

The present disclosure relates to an electronic control device and a method for generating random numbers.

### BACKGROUND

A conceivable technique teaches a pseudo random number generator.

### SUMMARY

According to an example, a plurality of random numbers is generated in an electronic control device having a function of generating the plurality of random numbers. A unique value that is different each time one of the random numbers is generated is acquired. An inherent value that is inherent to the electronic control device is acquired. One of the random numbers is generated using the unique value and the inherent value.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing a schematic configuration of an electronic control device according to a first embodiment;

FIG. 2 is a flowchart showing a processing operation of a diagnosis tool according to the first embodiment;

FIG. 3 is a flowchart illustrating the processing operation of the electronic control device according to the first embodiment;

FIG. 4 is a flowchart showing a random number generation process of the electronic control device according to the first embodiment;

FIG. 5 is a flowchart showing a random number generation process of the electronic control device according to a modification;

FIG. 6 is a block diagram showing a schematic configuration of an electronic control device according to a second embodiment; and

FIG. 7 is a flowchart showing a random number generation process of the electronic control device according to the second embodiment.

### DETAILED DESCRIPTION

Here, some electronic control devices have a function of generating random numbers using information for random number generation. Depending on the information, the electronic control device may generate random numbers with small variance. From the viewpoint described above or from other unmentioned viewpoints, there may be a demand for further improvement to the electronic control device.

One object of the present embodiments is to provide an electronic control device that can generate a different random number each time.

An electronic control device according to the present disclosure is an electronic control device having a function of generating a random number.

The electronic control device includes: a unique value acquisition unit that acquires a unique value that is different each time a random number is generated; an inherent value acquisition unit that acquires an inherent value that is inherent to the electronic control device; and a generation unit that generates a random number using the unique value and the inherent value.

In this manner, the electronic control device generates a random number using the unique value and the inherent value. Therefore, the electronic control device can generate a different random number each time.

The disclosed aspects in this specification adopt different technical solutions from each other in order to achieve their respective objectives. Reference numerals in parentheses described in claims and this section exemplarily show corresponding relationships with parts of embodiments to be described later and are not intended to limit technical scopes. The objects, features, and advantages disclosed in this specification will become apparent by referring to following detailed descriptions and accompanying drawings.

As follows, multiple embodiments for implementing the present disclosure will be described with reference to the drawings. In each embodiment, portions corresponding to those described in the preceding embodiment are denoted by the same reference numerals, and redundant descriptions will be omitted in some cases. In each of the embodiments, when only a part of the configuration is explained, the other part of the embodiment can be referred to the other embodiment explained previously and applied.

### First Embodiment

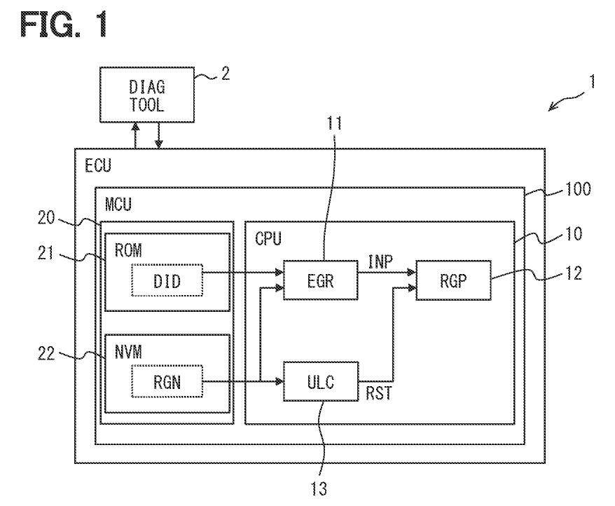

An electronic control device 1 according to a first embodiment will be described with reference to FIG. 1 to FIG. 4. The electronic control device 1 is configured to be mountable on a mobile object, for example. Examples of mobile objects include vehicles such as electric cars, hybrid cars, and fuel cell cars, flying objects such as electric vertical take-off and landing aircraft and drones, ships, construction machinery, and agricultural machinery. In this embodiment, an electronic control device 1 mounted on a vehicle is used as an example. Alternatively, the electronic control device 1 can be applied to other applications as well.

For example, the electronic control device 1 can be applied to a device that controls a motor as a control target. The motor may be one that assists the driver's steering force. Therefore, the electronic control device 1 can be applied to steering devices such as electric power steering system. Alternatively, the control target of the electronic control device 1 may be a device other than a motor.

### Configurations

The configuration of an electronic control device 1 will be described with reference to FIG. 1. The electronic control device 1 mainly includes a microcontroller 100 (hereinafter, referred to as a microcomputer). The electronic control device 1 may also include a communication device for communicating with an external device. In other words, the electronic control device 1 may be configured to be able to communicate with an external device. Furthermore, the electronic control device 1 may be provided with a plurality of sensors for detecting temperature, behavior of the control target, and the like. In the drawings, the electronic control device 1 is represented as an ECU, and the microcomputer 100 is represented as an MCU.

The external device is a device provided separately from the electronic control device 1. In this embodiment, a diagnosis tool 2 is used as an example of an external device. The diagnosis tool 2 is a device for diagnosing a fault in the electronic control device 1. The diagnosis tool 2 includes a processing unit such as a CPU, a storage unit such as a ROM and a RAM, and a communication unit for communicating with the electronic control device 1.

The electronic control device 1 performs authentication between the electronic control device 1 and the diagnosis tool 2 using random numbers, which will be described later. That is, the electronic control device 1 generates a random number for use in authenticating the diagnosis tool 2. The authentication process between the electronic control device 1 and the diagnosis tool 2 will be described in detail later.

Alternatively, the use of random numbers is not limited to this feature. The electronic control device 1 may, for example, generate random numbers for use in a variety of applications. Furthermore, the external device is not limited to the diagnosis tool 2. The external device may be, for example, a device mounted in the vehicle together with the electronic control device 1, a device mounted in another vehicle, a server installed in an external center, or the like. The external center is, for example, an OTA server. The OTA is an abbreviation of over the air.

The microcomputer 100 mainly includes a CPU 10 and a storage device 20. The storage device 20 includes a ROM 21 and an NVM 22, which are non-volatile memories, and a volatile memory. Furthermore, the microcomputer 100 is equipped with an input/output port and the like.

The CPU is abbreviation of Central Processing Unit. The ROM is an abbreviation for Read Only Memory. The volatile memory may be a DRAM or an SRAM. The DRAM is an abbreviation for Dynamic random access memory. The SRAM is an abbreviation for Static random access memory. The RAM is an abbreviation for Random Access Memory. The NVM is an abbreviation for non volatile memory.

The CPU 10 is configured to be able to access the ROM 21 and the NVM 22. The CPU 10 executes a program stored in the ROM 21. The CPU 10 executes a program to perform arithmetic processing. At this time, the CPU 10 performs the arithmetic processing using data stored in the volatile memory, data obtained from the input/output port, and the like. The CPU 10 performs various controls by outputting the results of the calculations from the input/output ports. The program is, for example, a control program. The control program corresponds to the control software.

Moreover, it can be said that the CPU 10 executes various functions by performing arithmetic processing. For this reason, the CPU 10 includes a plurality of functional blocks. The CPU 10 has, as functional blocks, for example, an entropy source generation unit 11, a random number generation unit 12, and an upper limit check unit 13. In the drawing, the entropy source generation unit 11 is represented as EGR, the random number generation unit 12 is represented as RGP, and the upper limit check unit 13 is represented as ULC.

The entropy source generation unit 11 generates an entropy input from the contents stored in the ROM 21 and the NVM 22. The entropy source generation unit 11 passes the generated entropy input to the random number generation unit 12. The random number generation unit 12 generates random numbers using the entropy input from the entropy source generation unit 11. The entropy input can also be referred to as input data.

In this manner, the electronic control device 1 has a function of generating random numbers. In the drawing, the entropy input is denoted as INP. Here, the passing can also be said to make a device available for reference.

The microcomputer 100 also has a function of counting the number of generation times of random numbers. The microcomputer 100 updates the count value every time the microcomputer 100 generates a random number. This count value is the number of generation times of the random number. The number of generation times of the random number is written to the NVM 22, which will be described later. That is, the CPU 10 updates the random number generation count stored in the NVM 22 every time a random number is generated. At this time, the CPU 10 erases the number of generation times of the random number stored in the NVM 22 and writes a new number of generation times of the random number to the NVM 22. The counting function may be included in the random number generation unit 12 or may be a functional block separate from the random number generation unit 12.

The upper limit check unit 13 checks (or verifies) whether the number of generation times of the random numbers has reached an upper limit. The upper limit check unit 13 compares the number of generation times of the random numbers in the NVM 22 with a predetermined upper limit. Then, the upper limit check unit 13 passes the check result, which is the result of comparing the number of generation times of the random number with the upper limit, to the random number generation unit 12. The upper limit value may be the number of times that the NVM 22 can be written (i.e., the writing limit value), or the like. The upper limit value is stored in the ROM 21, the NVM 22, or the like. In the drawings, the check result is indicated as RST.

The check result is a value indicating that the number of generation times of a random number has reached the upper limit, or a value indicating that the number of generation times of a random number has not reached the upper limit. A value indicating that the number of generation times of the random number has reached the upper limit can be said to be a check result of "NG". A value indicating that the number of generation times of the random number has not reached the upper limit can be said to be a check result that is "OK".

Furthermore, in this embodiment, as an example, the microcomputer 100 capable of acquiring diagnosis data is employed. The diagnosis data is data for diagnosing a malfunction of the electronic control device 1. That is, the microcomputer 100 acquires the sensor values output from the respective sensors as diagnosis data. The sensor values are stored in the NVM 22, which will be described later.

The ROM 21 is a read-only storage medium. The contents of the ROM 21 are written when the electronic control device 1 is manufactured. The contents written in the ROM 21 include a device ID, a program, and the like. The ROM 21 has a plurality of storage areas. It may be preferable that the device ID and the program are stored in different storage areas. In other words, the device ID is managed separately from the program.

The device ID is information that differs for each electronic control device 1. The device ID is a value inherent to the electronic control device 1. In other words, the device ID is a unique value for each of a plurality of electronic control devices 1 that have the same configuration and the same functions. The device ID is, for example, the serial number of the electronic control device 1. The device ID includes a model number, a manufacturing date, and the like. Therefore, the device ID can be said to be unique information. Furthermore, since the device ID is written into the ROM 21 during manufacturing as described above, its uniqueness can be guaranteed. The device ID corresponds to an inherent value.

The inherent values can also be considered as individual system data that differs for each electronic control device 1. The ROM 21 may be a PROM. The PROM is an abbreviation for Programmable ROM. In the drawings, the device ID is represented as DID.

The NVM 22 is a storage medium whose contents can be repeatedly erased and rewritten. The contents written to the NVM 22 include the number of generation times of random numbers. The number of generation times of a random number is a different value each time a random number is generated. In other words, the number of generation times of the random number is a unique value in the random number generation process in the microcomputer 100. The number of generation times of the random number corresponds to a unique value. EEPROM (registered trademark), flash memory, or the like can be used as the NVM 22. The EEPROM is an abbreviation of electrically Erasable Programable ROM.

In the drawings, the number of generation times of the random number is denoted as RGN. The number of generation times of the random number and the device ID can also be called generation information or generation data, which is information for generating random numbers.

The electronic control device 1 may be configured so that the program can be reprogrammable. In this case, the program is stored in a reprogrammable storage medium. This allows the electronic control device 1 to correct program defects and maintain the latest programs.

On the other hand, it may be preferable that the storage area in which the device ID is stored is an area that is not rewritten by reprogramming the program. This enables the electronic control device 1 to prevent the device ID from being erased. The microcomputer 100 may have an OTP function. In this case, the storage area in which the device ID is stored is located in an area different from the area to be reprogrammed. The microcomputer 100 can also control the storage area in which the device ID is stored to be OTP-compatible to prevent rewriting in a hardware manner. OTP is an abbreviation for One Time Programming.

### Processing

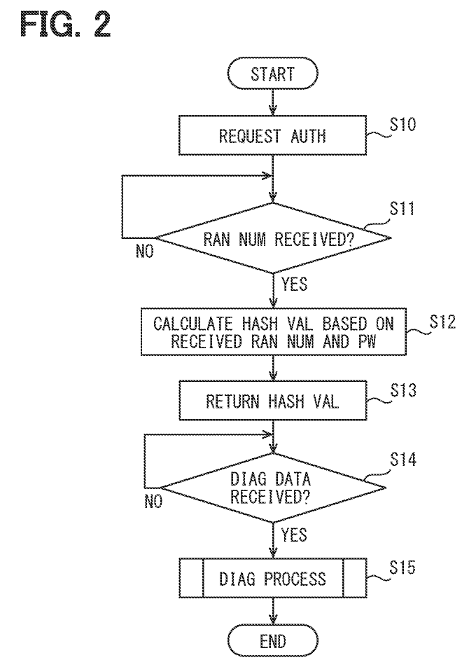

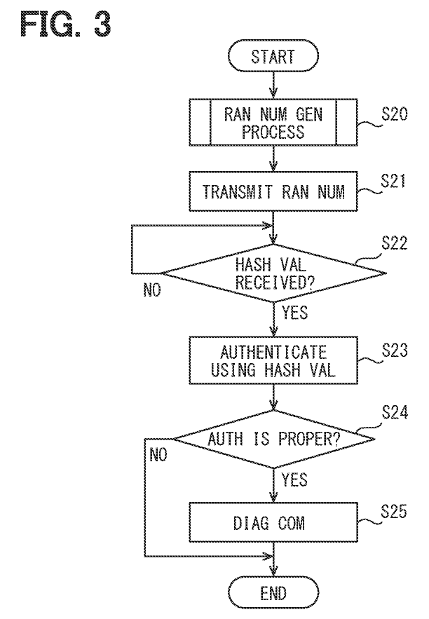

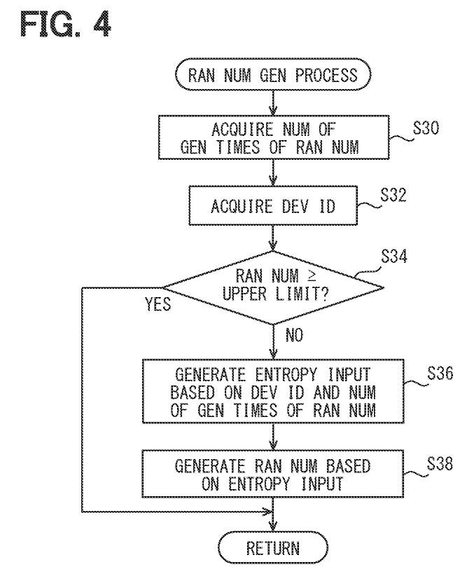

Here, the processing operation of the electronic control device 1 will be described with reference to FIG. 3 and FIG. 4. As described above, the electronic control device 1 communicates with the diagnosis tool 2 for fault diagnosis. At this time, the electronic control device 1 performs challenge-and-response authentication using random numbers in the authenticate of the diagnosis tool 2. Therefore, the processing operation of the diagnosis tool 2 will also be described with reference to FIG. 2. The processing operation of the electronic control device 1 are mainly performed by the CPU 10.

The diagnosis tool 2 starts the process shown in the flowchart of FIG. 2 in response to an instruction from an operator.

In step S10, an authentication request is made. The diagnosis tool 2 transmits a request signal to the electronic control device 1 to request the authentication.

In step S11, it is determined whether or not a random number has been received. When the diagnosis tool 2 determines that a random number has been received from the electronic control device 1, the process proceeds to step S12, and when the diagnosis tool 2 determines that a random number has not been received, the process repeats step S11. The diagnosis tool 2 receives a random number from the electronic control device 1 by making an authentication request.

In step S12, a hash value is calculated from the received random number and the password (i.e., PW). The diagnosis tool 2 uses the received random number and a predetermined password to calculate a hash value, which provides a response signal. In this example, a hash value is used as an example of the response signal. Alternatively, the diagnosis tool 2 may be any tool that calculates a response signal using random numbers.

The electronic control device 1 may transmit a data string generated from random numbers. In this case, the diagnosis tool 2 calculates a response signal using the data string. In other words, the electronic control device 1 may authenticate the diagnostic tool 2 using a value that correlates to a random number.

In step S13, the hash value is returned. In response to the received random number, the diagnosis tool 2 returns the hash value generated in step S12 to the electronic control device 1.

In step S14, it is determined whether or not the diagnosis data has been received. When the diagnosis tool 2 determines that the diagnostic data has been received from the electronic control device 1, the process proceeds to step S15, and when the diagnosis tool 2 determines that the diagnosis data has not been received, the process repeats step S14. The diagnosis tool 2 receives diagnostic data from the electronic control device 1 by returning a hash value. More specifically, when the diagnosis tool 2 determines that the communication partner is a valid partner through the authentication using a hash value, the diagnosis tool 2 receives the diagnosis data from the electronic control device 1.

In step S15, a diagnosis process is performed. The diagnosis tool 2 performs the diagnosis process on the electronic control device 1 using the received diagnosis data. That is, the diagnosis tool 2 performs a fault diagnosis on the electronic control device 1.

On the other hand, when an authentication request is made, the electronic control device 1 starts the process shown in the flowchart of FIG. 3. The flowchart in FIG. 3 illustrates processing performed by the CPU 10. Therefore, when the communication device receives a request signal, the CPU 10 starts the process of the flowchart in FIG. 3.

In step S20, a random number generation process is performed. This random number generation process will be explained in detail later. In this embodiment, as an example, a random number generation process is performed when an authentication request is received. Alternatively, the CPU 10 may perform the random number generation process at another timing. For example, the CPU 10 may perform the random number generation process when the ignition switch is switched from an off state to an on state. Furthermore, the CPU 10 may perform the random number generation process when the supply of operating power to the electronic control device 1 is started.

In step S21, a random number is transmitted. The CPU 10 transmits the random number generated in step S20 to the diagnosis tool 2. At this time, the CPU 10 transmits the random number via the communication device.

In step S22, it is determined whether a hash value has been received. When the CPU 10 determines that a hash value has been received from the diagnosis tool 2, the process proceeds to step S23, and when the CPU 10 determines that a hash value has not been received, the process repeats step S22. The CPU 10 receives a hash value from the diagnosis tool 2 by transmitting a random number. The electronic control device 1 receives the hash value via a communication device. Then, the CPU 10 acquires the received hash value.

In step S23, authentication is performed using the hash value. The CPU 10 authenticates the diagnosis tool 2 using the received hash value. That is, the CPU 10 calculates a hash value using random numbers, similar to the diagnosis tool 2. The CPU 10 authenticates the diagnosis tool 2 by comparing the received hash value with the calculated hash value.

In step S24, it is determined whether the authentication is successful. When both hash values match, the CPU 10 determines that the authentication is successful, and proceeds to step S25. In other words, when both hash values match, the CPU 10 determines that the diagnosis tool 2 that transmitted the hash value is a valid communication partner. Moreover, if the two hash values do not match, the CPU 10 determines that the authentication is not successful and ends the flow chart of FIG. 3. In other words, when both hash values does not match, the CPU 10 determines that the diagnosis tool 2 that transmitted the hash value is not a valid communication partner.

In step S25, diagnosis communication is performed. The CPU 10 transmits the diagnosis data to the diagnosis tool 2. The CPU 10 transmits the diagnosis data via the communication device.

Here, the random number generation process will be described with reference to FIG. 4.

In step S30, the number of generation times of random numbers is acquired (which corresponds to an unique value acquisition unit). The CPU 10 (i.e., the entropy source generation unit 11 ) acquires the number of generation times of the random numbers from the NVM 22. It can also be said that the CPU 10 refers to the number of generation times of the random numbers that is stored in the NVM 22. The number of generation times of the random numbers is the number of times that random numbers have been generated up to the random number generation process.

In this manner, the CPU 10 acquires the number of generation times of the random numbers for use in generating random numbers. The number of generation times of the random numbers is a unique value each time a random number is generated. Furthermore, when the CPU 10 generates a random number, the CPU 10 writes the generated random number to the NVM 22. The number of times that data can be written to the NVM 22 is limited. In other words, a finite limit can be placed on the generation of random numbers themselves. Therefore, the electronic control device 1 can reduce the probability that the generated random numbers will match.

In step S32, the device ID is acquired (which corresponds to the inherent value acquisition unit). The CPU 10 (i.e., the entropy source generation unit 11 ) acquires the device ID from the ROM 21. It can also be said that the CPU 10 refers to the device ID stored in the ROM 21. The CPU 10 may execute step S32 prior to step S30.

In step S34, it is determined whether or not the number of generation times of the random numbers is equal to or greater than the upper limit value (which corresponds to the determination unit). The CPU 10 (i.e., the upper limit check unit 13) compares the number of generation times of the random numbers stored in the NVM 22 with the upper limit value. Furthermore, the CPU 10 compares the number of generation times of the random numbers with the upper limit value to determine whether or not the number of generation times of the random numbers is obtainable.

When the CPU 10 determines that the number of generation times of the random number is smaller than the upper limit value, the CPU 10 defines that the number of generation times of the random numbers is obtainable and proceeds to step S36. The ability to acquire the number of generation times of the random numbers indicates that it is possible to acquire the number of generation times of the random numbers, which is a unique value each time a random number is generated. When the upper limit check unit 13 determines that the number of generation times of the random numbers is smaller than the upper limit value, the upper limit check unit 13 passes a value indicating that the number of generation times of the random numbers has not reached the upper limit value to the random number generation unit 12 as the check result.

On the other hand, when the CPU 10 determines that the number of generation times of the random numbers is equal to or greater than the upper limit value, the CPU 10 determines that it is not possible to acquire the number of generation times of the random numbers, and ends the flow chart of FIG. 4. When the number of generation times of the random numbers has reached the upper limit value, the number of generation times of the random numbers stored in the NVM 22 is not updated. Therefore, the CPU 10 cannot acquire the number of generation times of the random numbers, which is a unique value each time a random number is generated. That is, the CPU 10 acquires the number of generation times of the random numbers that is the same as the upper limit value.

Even if the CPU 10 generates random numbers using such the number of generation times of the random numbers, there is a risk that it will not be able to generate random numbers with large variance. Therefore, if the number of generation times of the random numbers has reached the upper limit value, the CPU 10 ends the flow chart of FIG. 4 without generating any more random numbers.

The inability to acquire the number of generation times of the random numbers indicates that it is not possible to acquire the number of generation times of the random numbers, which is a unique value each time a random number is generated. In other words, when the number of generation times of the random numbers cannot be acquired, this indicates that although the number of generation times of the random numbers can be obtained, the number of generation times of the random numbers obtained will be the same value. When the upper limit check unit 13 determines that the number of generation times of the random numbers is equal to or greater than the upper limit value, the upper limit check unit 13 passes a value indicating that the number of generation times of the random numbers has reached the upper limit value to the random number generation unit 12 as the check result.

Furthermore, it is conceivable that an attacker (i.e., improper user) may attempt to generate random numbers in the electronic control device 1. The electronic control device 1 can limit the number of attempts by an attacker by setting an upper limit value on the number of generation times of the random numbers. The upper limit value may be a value smaller than the number of times the NVM 22 can be written. This allows the electronic control device 1 to further limit the number of attempts made by an attacker.

In step S36, an entropy input is generated from the device ID and the number of generation times of the random numbers. The CPU 10 (i.e., the entropy source generation unit 11) generates an entropy input from the number of generation times of the random numbers and the device ID acquired in steps S30 and S32. The entropy source generation unit 11 passes the generated entropy input to the random number generation unit 12.

The entropy source generation unit 11 generates an entropy input by combining a value indicating the number of generation times of the random numbers and a value indicating a device ID. For example, the entropy input is generated by concatenating a value indicating the number of times a random number is generated and a value indicating the device ID. Alternatively, an entropy input may be generated by performing an XOR (i.e., exclusive OR) operation on a value indicating the number of generation times of the random numbers and a value indicating the device ID. Alternatively, the method of generating the entropy input is not limited to these features. The entropy input generated from the number of generation times of the random numbers and the device ID can be defined to be a value that correlates with the number of generation times of the random numbers and the device ID.

In step S38, a random number is generated from the entropy input (which corresponds to the generation unit). The CPU 10 (i.e., the random number generation unit 12) generates a random number using the entropy input generated in step S36. The entropy source generation unit 11 and the random number generation unit 12 may be one functional block.

The CPU 10 generates random numbers, for example, in accordance with a predetermined standard. That is, the CPU 10 generates a seed value from the entropy input and generates random numbers using the seed value. In other words, the CPU 10 generates random numbers in a secure manner. Alternatively, the CPU 10 may generate random numbers in a manner other than the standard.

As described above, the CPU 10 executes steps S36 and S38 only if the number of generation times of the random numbers has not reached the upper limit value. In other words, the CPU 10 generates the entropy input and the random numbers only when the number of generation times of the random numbers has not reached the upper limit value. It can also be said that the CPU 10 generates the entropy input and the random numbers only when the CPU 10 can acquire the number of generation times of the random numbers, which is a unique value each time the random number is generated.

It can also be said that the CPU 10 generates a random number using a value that correlates with the number of generation times of the random numbers and a value that correlates with the device ID. Furthermore, it can be said that the CPU 10 generates a random number from an entropy input including the number of generation times of the random numbers and the device ID.

The CPU 10 generates a random number for use in authenticating the diagnosis tool 2. Alternatively, the CPU 10 may generate in advance a plurality of random numbers to be used for different purposes (which corresponds to the random number generation unit). For example, in step S38, the CPU 10 generates random numbers to be used for authentication of the diagnosis tool 2 as well as for other purposes. At this time, the CPU 10 generates random number data including a plurality of random numbers for different purposes, and stores the random number data in the NVM 22 or the like. When the CPU 10 uses a random number, the CPU 10 reads the random number from the NVM 22 according to the purpose and uses the random number. This enables the electronic control device 1 to reduce the number of times the CPU 10 performs the random number generation processing.

### Effects

In this manner, the electronic control device 1 generates a random number using the number of generation times of the random numbers, which is a unique value, and the device ID, which is an inherent value. Therefore, the electronic control device 1 can generate a different random number each time for a specific application. It can also be said that the electronic control device 1 can generate random numbers with large variance. In other words, the electronic control device 1 can increase the variance in the random numbers to be generated. It can also be said that the electronic control device 1 can reduce the regularity of the random numbers to be generated.

Moreover, the device ID is different for each electronic control device 1. On the other hand, the number of generation times of the random numbers is a different value each time a random number is generated. Therefore, even if an attacker performs analysis using random numbers acquired from another electronic control device, it is difficult for the attacker to acquire the number of generation times of the random numbers or the device ID from the analysis information.

Furthermore, the electronic control device 1 performs authentication between the electronic control device 1 and the diagnosis tool 2 using the generated random number. The electronic control device 1 can generate random numbers with large variance, thereby improving confidentiality in authentication.

In this embodiment, an example is shown that only the number of generation times of the random numbers is used as a unique value. Alternatively, the present disclosure may also use a unique value that combines the number of generation times of the random numbers with another value. The other values are values acquired by the electronic control device 1, and acquisition values that are different every time the electronic control device 1 is activated can be used. The CPU 10 acquires an acquisition value in step S30. The acquisition values include, for example, the number of times the ignition switch is turned on, the odometer value, and time information. In addition, in this embodiment, an acquisition value can be used as the unique value instead of the number of generation times of the random numbers.

### Modifications

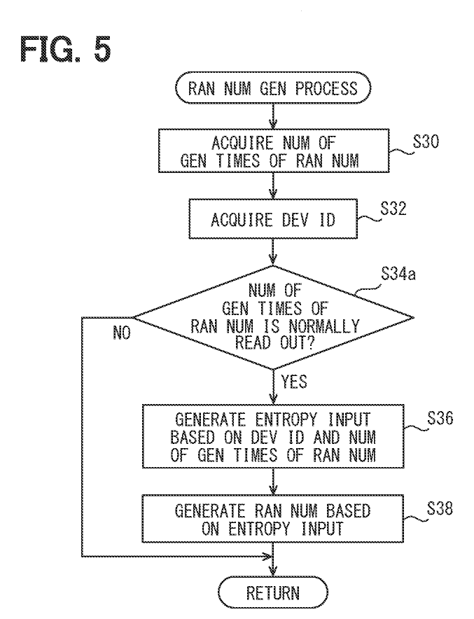

A modified example of the electronic control device 1 will be described with reference to FIG. 5. As shown in FIG. 5, the CPU 10 may execute step S34a instead of step S34.

In step S34a, it is determined whether the number of generation times of the random numbers has been read normally or not (which corresponds to the determination unit). If the CPU 10 determines that the number of generation times of the random numbers has been read normally, the CPU 10 defines that the number of generation times of the random numbers can be acquired and proceeds to step S36. If the CPU 10 determines that the number of generation times of the random numbers could not be read normally, the CPU 10 defines that the number of generation times of the random numbers cannot be acquired and ends the flow chart of FIG. 5. According to this configuration, the electronic control device 1 achieves the same effects as those described above.

### Second Embodiment

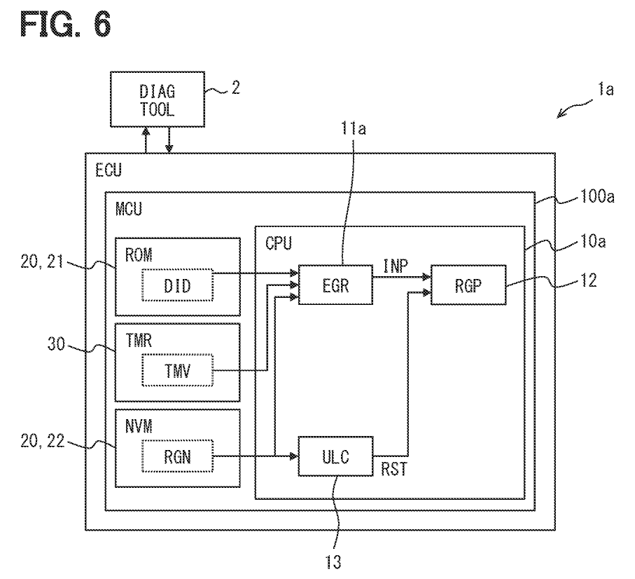

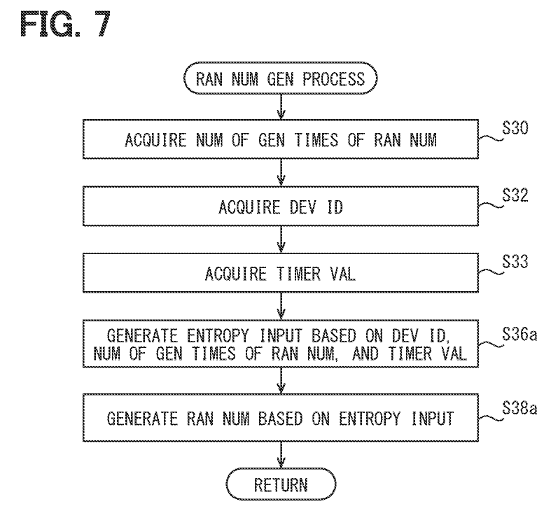

With reference to FIGS. 6 and 7, the electronic control device 1a according to a second embodiment will be described. Here, differences between the electronic control device 1a and the electronic control device 1 will be mainly described. The electronic control device 1 differs from the electronic control device 1a such that the configuration of the microcomputer 100a and the process operation of the CPU 10a are different from the microcomputer 100.

As shown in FIG. 6, the microcomputer 100 a includes a free-running timer 30 in addition to the configuration of the microcomputer 100. The free-running timer 30 is cleared when the power is turned on or when the timer is reset, and then starts counting up. The free-running timer 30 outputs a counted-up timer value. In the drawing, the free-running timer 30 is represented as TMR, and the timer value is represented as TMV.

Moreover, the microcomputer 100a includes a CPU 10a instead of the CPU 10. The CPU 10a differs from the CPU 10 in that a timer value is input and in the processing operation.

Here, the random number generation process of the CPU 10a will be described with reference to FIG. 7. In FIG. 7, the same step numbers are assigned to the same processes as in FIG. 4.

In step S33, the timer value is acquired (which corresponds to the timer value acquisition unit). The CPU 10a acquires the timer value of the free-running timer. The order in which the CPU 10a executes steps S30, S32, and S33 is not particularly limited.

In step S36a, an entropy input is generated from the device ID, the number of generation times of the random numbers, and the timer value. The CPU 10a (i.e., the entropy source generation unit 11a) generates an entropy input from the number of generation times of the random numbers, the device ID, and the timer value acquired in steps S30, S32, and S33. The entropy source generation unit 11 passes the generated entropy input to the random number generation unit 12.

The entropy source generation unit 11 generates an entropy input by combining a value indicating the number of generation times of the random numbers, a value indicating a device ID and a timer value. For example, the entropy input is generated by concatenating a value indicating the number of times a random number is generated, a value indicating the device ID and the timer value. Alternatively, an entropy input may be generated by performing an XOR (i.e., exclusive OR) operation on a value indicating the number of generation times of the random numbers, a value indicating the device ID and the timer value. Alternatively, the method of generating the entropy input is not limited to these features. In addition, the entropy input generated from the number of generation times of the random numbers, the device ID, and the timer value can be said to be a value that correlates with the number of generation times of the random numbers, the device ID, and the timer value. The timer value can also be defined as generation information or generation data, which is information for generating random numbers.

In step S38a, a random number is generated from the entropy input (which corresponds to the generation unit). The CPU 10a (i.e., the random number generation unit 12) generates a random number using the entropy input generated in step S36a. The method of generating random numbers is the same as in the first embodiment.

It can also be said that the CPU 10 generates a random number using a value correlating with the number of generation times of the random numbers, a value correlating with the device ID, and a value correlating with the timer value. Furthermore, it can be said that the CPU 10 generates a random number from an entropy input including the number of generation times of the random numbers, the device ID and the timer value.

The electronic control unit 1a can achieve the same effects as the electronic control unit 1. Furthermore, the electronic control unit 1a generates a random number using the timer value. Therefore, the electronic control unit 1a can generate random numbers with greater variance than the electronic control unit 1. Note that, similar to the CPU 10, the CPU 10a may execute steps S36a and S38a only when the number of generation times of the random numbers has not reached the upper limit value.

In addition, the CPU 10a generates random numbers using only a pat of the number of generation times of the random numbers, the device ID, and the timer value, and by performing an input addition process, the CPU 10a may generate random numbers using all of the number of generation times of the random numbers, the device ID, and the timer value (which corresponds to the generation unit). That is, the CPU 10a generates a seed value using only a part of the number of generation times of the random numbers, the device ID, and the timer value, and generates a random number from the seed value (which corresponds to the basic generation unit). Then, the CPU 10a performs an input addition process to generate a seed value by adding generation information that is not used in the first generation unit, including the number of generation times of the random numbers, the device ID, and the timer value, and generates a random number from that seed value (which corresponds to the addition generation unit). Note that "only a part" refers to one of the number of generation times of the random numbers, the device ID, and the timer value, or two of the number of generation times of the random numbers, the device ID, and the timer value.

For example, the CPU 10a generates a seed value using only the timer value, and generates a random number from the seed value. Then, the CPU 10a performs an input addition process to generate a seed value using the number of generation times of the random numbers and the device ID in addition to the timer value, and generates a random number from the seed value. The timer value can also be referred to as the first entropy input. On the other hand, the number of generation times of the random numbers and the device ID can be considered as additional entropy input. In this way, the CPU 10a can generate a random number using all of the number of generation times of the random numbers, the device ID, and the timer value by performing the input addition process.

In this embodiment, the device ID is stored in the ROM 21. Alternatively, the present disclosure is not limited to this feature. The device ID may be stored in the NVM 22. Furthermore, a portion of the area in the ROM 21 may be allocated as a storage destination for the number of generation times of the random numbers.

Furthermore, the CPU 10a can employ CtrDRBG as a random number generation algorithm. In this case, the CPU 10a can generate random numbers using the first entropy input and the additional entropy input by executing the process defined by the Reseed Function.

Although the present disclosure has been described in accordance with the foregoing embodiments, it is understood that the present disclosure is not limited to the above embodiments or structures. The present disclosure also includes various modification examples and modifications within an equivalent range. In addition, while the various elements are shown in various combinations and configurations, which are exemplary, other combinations and configurations, including more, less or only a single element, are also within the spirit and scope of the present disclosure.

### Technical feature

The embodiments teaches multiple technical features described in multiple items listed below. Some items may be written in a multiple dependent form with subsequent items referring to the preceding item as an alternative. Alternatively, some features may be described in a multiple dependent form referring to another multiple dependent form. These features described in a multiple dependent form define multiple technical features.

### Technical feature 1

An electronic control device having a function of generating a plurality of random numbers, includes: at least one of (i) a circuit and (ii) a processor having a memory storing computer program code. The at least one of the circuit and the processor having the memory is configured to cause the electronic control device to provide at least one of: a unique value acquisition unit that acquires a unique value that is a unique value each time one of the random numbers is generated; an inherent value acquisition unit that acquires an inherent value that is inherent to the electronic control device; and a generation unit that generates one of the random numbers using the unique value and the inherent value.

### Technical Feature 2

The electronic control device according to the technical feature 1 further includes: a timer value acquisition unit that acquires a timer value of a free-running timer. The generation unit generates one of the random numbers by using the unique value, the inherent value, and the timer value.

### Technical Feature 3

In the electronic control device according to the technical feature 1 or 2, the unique value acquisition unit acquires a numerical number of generation times of the random numbers generated by the generation unit as the unique value.

### Technical Feature 4

In the electronic control device according to any one of the technical features 1 to 3, the unique value acquisition unit acquires a different value as the unique value each time the electronic control device is activated.

### Technical Feature 5

The electronic control device according to any one of the technical features 1 to 4 further includes: a determination unit that determines whether or not the unique value acquisition unit is capable of acquiring the unique value. The generation unit stops generating one of the random numbers when determining that the unique value cannot be acquired.

### Technical Feature 6

In the electronic control device according to the technical feature 2, the generation unit generates one of the random numbers using only a part of the unique value, the inherent value and the timer value. The generation unit generates one of the random numbers using all of the unique value, the inherent value, and the timer value by performing an input addition process.

### Technical Feature 7

The electronic control device according to any one of the technical features 1 to 6 further includes: a storage device that stores a control software and the inherent value. The inherent value is written into the storage device during a manufacturing process of the electronic control device.

### Technical Feature 8

In the electronic control device according to the technical feature 7, the control software and the inherent value are stored in different storage areas of the storage device. The storage area in which the inherent value is stored is an area that is not rewritten by reprogramming the control software.

### Technical Feature 9

In the electronic control device according to any one of the technical features 1 to 8, the generation unit generates in advance the plurality of random numbers to be used for different purposes.

### Technical Feature 10

In the electronic control device according to any one of the technical features 1 to 9, a motor is controlled as a control target.

### Technical Feature 11

In the electronic control device according to any one of the technical features 1 to 10, communication with an external device disposed outside of the electronic control device is executable. Authentication with the external device is performed using one of the random number generated by the generation unit.

In the present disclosure, the term "processor" may refer to a single hardware processor or several hardware processors that are configured to execute computer program code (i.e., one or more instructions of a program). In other words, a processor may be one or more programmable hardware devices. For instance, a processor may be a general-purpose or embedded processor and include, but not necessarily limited to, CPU (a Central Processing Circuit), a microprocessor, a microcontroller, and PLD (a Programmable Logic Device) such as FPGA (a Field Programmable Gate Array).

The term "memory" in the present disclosure may refer to a single or several hardware memory configured to store computer program code (i.e., one or more instructions of a program) and/or data accessible by a processor. A memory may be implemented using any suitable memory technology, such as static random-access memory (SRAM), synchronous dynamic RAM (SDRAM), nonvolatile/Flash-type memory, or any other type of memory. Computer program code may be stored on the memory and, when executed by a processor, cause the processor to perform the above-described various functions.

In the present disclosure, the term "circuit" may refer to a single hardware logical circuit or several hardware logical circuits (in other words, "circuitry") that are configured to perform one or more functions. In other words (and in contrast to the term "processor"), the term "circuit" refers to one or more non-programmable circuits. For instance, a circuit may be IC (an Integrated Circuit) such as ASIC (an application- specific integrated circuit) and any other types of non-programmable circuits.

In the present disclosure, the phrase "at least one of (i) a circuit and (ii) a processor" should be understood as disjunctive (logical disjunction) where the circuit and the processor can be optional and not be construed to mean "at least one of a circuit and at least one of a processor". Therefore, in the present disclosure, the phrase "at least one of a circuit and a processor is configured to cause an electronic control device to perform functions" should be understood that (i) only the circuit can cause an electronic control device to perform all the functions, (ii) only the processor can cause an electronic control device to perform all the functions, or (iii) the circuit can cause an electronic control device to perform at least one of the functions and the processor can cause an electronic control device to perform the remaining functions. For instance, in the case of the above-described (iii), function A and B among the functions A to C may be implemented by a circuit, while the remaining function C may be implemented by a processor.

It is noted that a flowchart or the processing of the flowchart in the present application includes sections (also referred to as steps), each of which is represented, for instance, as S10. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An electronic control device having a function of generating a plurality of random numbers, the electronic control device comprising:
a unique value acquisition unit that acquires a unique value that is different each time one of the random numbers is generated;
an inherent value acquisition unit that acquires an inherent value that is inherent to the electronic control device; and
a generation unit that generates one of the random numbers using the unique value and the inherent value.

2. The electronic control device according to claim 1, further comprising:
a timer value acquisition unit that acquires a timer value of a free-running timer, wherein:
the generation unit generates one of the random numbers by using the unique value, the inherent value, and the timer value.

3. The electronic control device according to claim 1, wherein:
the unique value acquisition unit acquires a numerical number of generation times of the random numbers generated by the generation unit as the unique value.

4. The electronic control device according to claim 1, wherein:
the unique value acquisition unit acquires a different value as the unique value each time the electronic control device is activated.

5. The electronic control device according to claim 1, further comprising:
a determination unit that determines whether or not the unique value acquisition unit is capable of acquiring the unique value, wherein:
the generation unit stops generating the random numbers when the determination unit determines that the unique value acquisition unit is not capable of acquiring the unique value.

6. The electronic control device according to claim 2, wherein:
the generation unit generates one of the random numbers using only a part of the unique value, the inherent value, and the timer value; and
the generation unit generates one of the random numbers using all of the unique value, the inherent value, and the timer value by performing an input addition process.

7. The electronic control device according to claim 1, further comprising:
a storage device that stores a control software and the inherent value, wherein:
the inherent value is written in the storage device during a manufacturing process of the electronic control device.

8. The electronic control device according to claim 7, wherein:
the control software and the inherent value are stored in different storage areas of the storage device; and
the storage area in which the inherent value is stored is an area that is not rewritten by reprogramming the control software.

9. The electronic control device according to claim 1, wherein:
the generation unit generates in advance the plurality of random numbers to be used for different purposes.

10. The electronic control device according to claim 1, wherein:
the electronic control device controls a motor as a control target.

11. The electronic control device according to claim 1, wherein:
communication with an external device disposed outside of the electronic control device is executable; and
the random number generated by the generation unit is used to perform authentication with the external device.

12. The electronic control device according to claim 1, further comprising:
at least one of (i) a circuit and (ii) a processor having a memory storing computer program code, wherein:
the at least one of the circuit and the processor having the memory is configured to cause the electronic control device to provide at least one of: the unique value acquisition unit; the inherent value acquisition unit; and the generation unit.

13. A method for generating a plurality of random numbers in an electronic control device, the method comprising:
acquiring a unique value that is different each time one of the random numbers is generated;
acquiring an inherent value that is inherent to the electronic control device; and generating one of the random numbers using the unique value and the inherent value.
